(19) United States
(12) Patent Application Publication
(10) Pub. No.: US 2015/0253274 A1
(43) Pub. Date: Sep. 10, 2015

(54) HYDROPHILIC FILM, METHOD OF MANUFACTURING THEREOF, AND BIOSENSOR HAVING THE HYDROPHILIC FILM

(71) Applicants: TSUNG-JU LEE, Hsin-Chu (TW); FANG-HSUAN SU, Hsin-Chu (TW); HUNG-TA CHIEN, Hsin-Chu (TW)

(72) Inventors: TSUNG-JU LEE, Hsin-Chu (TW); FANG-HSUAN SU, Hsin-Chu (TW); HUNG-TA CHIEN, Hsin-Chu (TW)

(73) Assignee: CORETRONIC CORPORATION, Hsin-Chu (TW)

(21) Appl. No.: 14/559,138

(22) Filed: Dec. 3, 2014

(30) Foreign Application Priority Data
Mar. 5, 2014 (TW) 103107506

(51) Int. Cl. G01N 27/30; B29C 59/16

(52) U.S. Cl. CPC G01N 27/30; B29C 59/16

(57) ABSTRACT

A hydrophilic film for a biosensor configured to sense a liquid sample, the hydrophilic film includes a substrate and at least one hydrophilic layer. The hydrophilic layer is disposed on the substrate and includes several first microstructures, several second microstructures, and several grooves, in which the first microstructures protrude in a direction opposite to the substrate, each of the grooves is formed between two of the first microstructures, the second microstructures are disposed on the first microstructures, the liquid sample contacts with the hydrophilic layer to form a contact angle, and the contact angle is less than 30 degree.

### FIELD OF THE INVENTION

The invention relates to a hydrophilic film, and more particularly to a hydrophilic film applied to a biosensor.

### BACKGROUND OF THE INVENTION

The concepts of the home health care has been taken into account in the present society, in which home health care sensing products includes several advantages such as rapidly sensing, low cost, no needing of the operation with the profession and the home health care sensing products are increasingly on the upgrade. For example, the home health care sensing products may include blood glucose meters, electrical ear thermometers, electric sphygmomanometers, and so on, in which several disposable glucose test strips of the blood glucose meters can be used to detect the blood glucose concentration of a blood sample according to the electrochemistry bio-sensing principle.

At present, the market is flooded with the blood glucose test strips, in which each of the blood glucose test strips has a hydrophilic film and the hydrophilic film is a plane structure. However, owing to the plane structure, a distance of a liquid diffusion on the hydrophilic film and a speed of the liquid diffusion on the hydrophilic film are limited such that the sensing precision of the blood glucose test strips may be difficult to increase, and thus the quantity of the samples may be increased (e.g. larger than 3 microliters) to make the blood glucose test strips having the plane hydrophilic films be able to sense blood glucose assuredly. However, the increasing quantities of the samples are heavy burdens for old people or people with diabetes mellitus who have to collect the blood samples for testing everyday. Furthermore, the plane hydrophilic films are easy to be attached to each other when the hydrophilic films are stacked together, causing inconveniences in manufacturing the hydrophilic films and increasing risks of the adsorptive effects resulting in malfunction.

For example, U.S. Pat. No. 7,223,364 discloses a biosensor having a film to control the flow of the sample, but the film is designed for the larger quantity of samples (e.g. larger than 10 microliters). Thus, the structure of the film can not accomplish the needing of decreasing the quantity of the samples.

Therefore, how to solve the above problems already becomes the focus of the relative field.

### SUMMARY OF THE INVENTION

One of the objects of the invention provides a hydrophilic film for a biosensor to increase the flow efficiency of the liquid samples and to adjust the flow speed of the liquid samples, such that the required quantity of the liquid samples is decreased and the sensing precision of the biosensor is increased.

Another one of the objects of the invention provides a method of manufacturing a hydrophilic film of a biosensor, and the method provides simple manufacturing steps of the hydrophilic film, in which the hydrophilic film could increase the flow efficiency of the liquid samples and adjust the flow speed of the liquid samples, such that the required quantity of the liquid samples is decreased and the sensing precision of the biosensor is increased.

Another one of the objects of the invention provides a biosensor to increase the flow efficiency of the liquid samples and to adjust the flow speed of the liquid samples, such that the required quantity of the liquid samples is decreased and the sensing precision of the biosensor is increased.

According to an embodiment of the invention, a hydrophilic film for a biosensor configured to sense a liquid sample, the hydrophilic film includes a substrate and at least one hydrophilic layer. The hydrophilic layer is disposed on the substrate and includes several first microstructures, several second microstructures, and several grooves, in which the first microstructures protrude in a direction opposite to the substrate, each of the grooves is formed between two of the first microstructures, the second microstructures are disposed on the first microstructures, the liquid sample contacts with the hydrophilic layer to form a contact angle, and the contact angle is less than 30 degree.

According to another embodiment disclosed herein, the substrate includes a first surface and a second surface opposite to the first surface and the hydrophilic layer is disposed on the first surface of the substrate.

According to another embodiment disclosed herein, the substrate comprises a first surface and a second surface opposite to the first surface, and when the number of the hydrophilic layers is two, the hydrophilic layers are respectively disposed on the first surface and the second surface of the substrate.

According to another embodiment disclosed herein, each of the second microstructures is a bump protruding in a direction away from the first micro structures.

According to another embodiment disclosed herein, each of the second microstructures is a recession descending in a direction toward the first micro structures.

According to another embodiment disclosed herein, the second microstructures include several recessions descending in a direction toward the first microstructures and several bumps protruding in a direction away from the first microstructures.

According to another embodiment disclosed herein, the second microstructures form a discontinuous grain disposed on the first micro structures.

According to another embodiment disclosed herein, each of the first microstructures is a semi-cylinder with an arc protruding in the direction opposite to the substrate.

According to another embodiment disclosed herein, each of the first microstructures is a triangular prism including a first ramp and a second ramp.

According to another embodiment of the invention, a method of manufacturing a hydrophilic film includes several steps as following. A mold is provided and includes several first graphs and several second graphs distributed on the first graph. A pre-hydrophilic film is provided and includes a substrate and a hydrophilic layer disposed on the substrate. An imprint step is processed and used for imprinting the pending hydrophilic film with the mold to form several first microstructures located on the hydrophilic layer and several second microstructures distributed on the first microstructures, in which each of the grooves is formed between two of the first microstructures, a shape of each of the first microstructures is contrary to one of the first graphs, and a shape of each of the second microstructures is contrary to one of the second graphs.

According to another embodiment disclosed herein, the mold is a roller.

According to another embodiment disclosed herein, the method further includes a step as following. A curing step is processed and used for curing the hydrophilic layer on the pre-hydrophilic film to form a hydrophilic film.

According to another embodiment disclosed herein, the curing step includes an ultraviolet curing or a thermal curing.

According to another embodiment of the invention, a biosensor is used for sensing a liquid sample and the biosensor includes an insulated substrate and a hydrophilic film. The insulated substrate includes a reacting area and at least two electrodes passing into the reacting area. The hydrophilic film is disposed on the insulated substrate and covers the electrodes. The hydrophilic film includes a substrate and at least one hydrophilic layer. The hydrophilic layer is disposed on the substrate and includes several first microstructures, several second microstructures, and several grooves, in which the first microstructures protrude in a direction opposite to the substrate, each of the grooves is formed between two of the first microstructures, the second microstructures are disposed on the first microstructures, the liquid sample contacts with the hydrophilic layer to form a contact angle, and the contact angle is less than 30 degree.

According to another embodiment disclosed herein, the biosensor further includes a cover covering the hydrophilic film opposite to the insulated substrate.

According to another embodiment disclosed herein, each of the second microstructures is a bump protruding in a direction away from the first micro structures.

According to another embodiment disclosed herein, each of the second microstructures is a recession descending in a direction toward the first micro structures.

According to another embodiment disclosed herein, the second microstructures include a plurality of recessions descending in a direction toward the first microstructures and a plurality of bumps protruding in a direction away from the first microstructures.

The hydrophilic film of the biosensor in the invention has the first microstructures and the second microstructures disposed on the first microstructures, in which each of the grooves is formed between two of the first microstructures, such that the flow efficiency of the liquid samples is increased and the flow speed of the liquid samples may be adjusted, and thus the required quantity of the liquid samples is decreased and the sensing precision of the biosensor is increased. In addition, the hydrophilic films do not attach to each other to enhance the manufacturing efficiency and to prevent from risks of the adsorptive effects when several the hydrophilic films are stacked with each other.

### BRIEF DESCRIPTION OF THE DRAWINGS

The invention will become more readily apparent to those ordinarily skilled in the art after reviewing the following detailed description and accompanying drawings, in which:

FIG. 1 illustrates an exploded view of a biosensor according to an embodiment of the invention;

FIG. 2 illustrates a three dimensional view of a hydrophilic film of FIG. 1;

FIG. 3 illustrates a schematic view of a hydrophilic layer of FIGS. 1 and 2 when the hydrophilic layer is contacted with a liquid sample;

FIG. 4 illustrates a three dimensional view of a hydrophilic film according to another embodiment of the invention;

FIG. 5 illustrates a three dimensional view of a hydrophilic film according to another embodiment of the invention;

FIG. 6 illustrates a three dimensional view of a hydrophilic film according to another embodiment of the invention; and

FIGS. 7A-7D illustrate flow charts of a method of manufacturing a hydrophilic film according to an embodiment of the invention.

### DETAILED DESCRIPTION OF PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

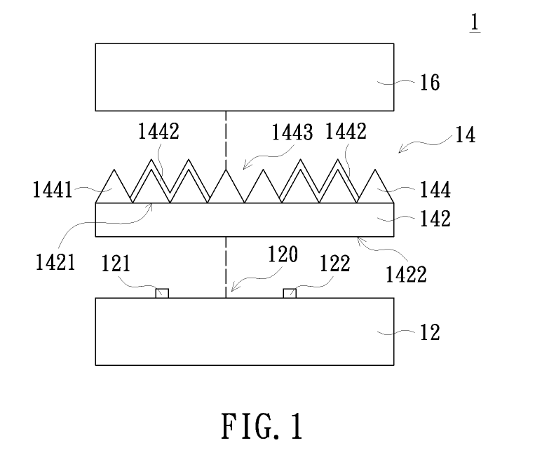

Referring to FIG. 1, FIG. 1 shows an exploded view of a biosensor according to an embodiment of the invention. The biosensor of the embodiment is used for sensing a liquid sample. For example, the liquid sample may be blood. As shown in FIG. 1, the biosensor 1 includes an insulated substrate 12, a hydrophilic film 14, and a cover 16. The insulated substrate 12 includes a reacting area 120 and at least two electrodes 121/122 contacting the reacting area 120. The hydrophilic film 14 is disposed on the insulated substrate 12 and covering the electrodes 121/122. The cover 16 is disposed opposite to the insulated substrate 12 and covers the hydrophilic film 14. As following, the structure of the hydrophilic film 14 would be furthering described.

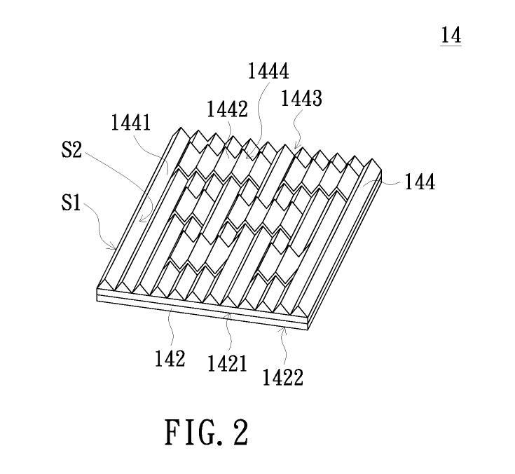

Referring to FIGS. 1 and 2, FIG. 2 shows a three dimensional view of a hydrophilic film of FIG. 1. As shown in FIG. 2, the hydrophilic film 14 includes a substrate 142 and at least one hydrophilic layer 144. The substrate 142 includes a first surface 1421 and a second surface 1422 opposite to the first surface 1421 and the hydrophilic layer 144 is disposed on the first surface 1421 of the substrate 142. The hydrophilic layer 144 includes several first microstructures 1441, several second microstructures 1442, and several grooves 1443. The first microstructures 1441 protrude from the hydrophilic layer 144 in a direction away from the substrate 142. Each of the grooves 1443 is formed between one of the first microstructures 1441 and the adjacent one of the first microstructures 1441 and configured to guide the liquid sample. The second microstructures 1442 are dispersed on the first microstructures 1441 to form a grain 1444 disposed on the first microstructures 1441. The grain 1444 is discontinuous or unsymmetrical. The concave-convex shape, density, width, depth, spacing or quantity of the grain 1444 may be adjusted, so as to control the diverse fluid speed of the liquid sample in different areas of the hydrophilic film 14.

In this embodiment, each of the first microstructures 1441 is a triangular prism including a first ramp S1 and a second ramp S2. In the other words, each of the first microstructures 1441 has a reversed V-shaped microstructure and each of the grooves 1443 has a V-shaped microstructure. Each of the second microstructures 1442 is a bump forming on the first microstructures 1441. The bumps are discontinuously and unsymmetrically distributed on the first microstructures 1441. In the other words, the bumps form the grain 1444 and the grain 1444 is discontinuous and unsymmetrical. In addition, each of the first microstructures 1441 may be, but not limited to, a semi-cylinder with an arc protruding in the direction opposite to the substrate 142. The shapes of the first microstructures 1441 may be manipulated to meet the requirement in regulating the flow direction and flow speed of the liquid sample, and thus the invention is not limited thereto.

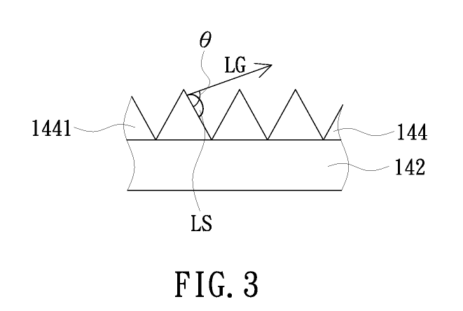

FIG. 3 shows a schematic view of the hydrophilic layer 144 of FIGS. 1 and 2 when the hydrophilic layer 144 is contacted with the liquid sample LS. As shown in FIG. 3, the liquid sample LS contacts with the hydrophilic layer 144 to form a contact angle θ, and the contact angle θ is less than 30 degree because of the material characteristics of the hydrophilic layer 144. It should be understood that the contact angle θ is formed between a surface of the hydrophilic layer 144 (that is a surface of one of the first microstructures 1441 or the second microstructures 1442) and a direction of surface tension LG between the liquid sample LS and the air around the environment.

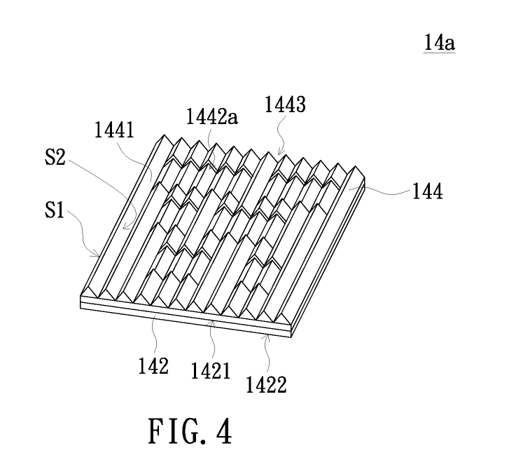

Referring to FIG. 4, FIG. 4 shows a three dimensional view of a hydrophilic film according to another embodiment of the invention. As shown in FIG. 4, in this embodiment, each of the second microstructures 1442a of the hydrophilic film 14a is a recession forming on the first microstructures 1441.

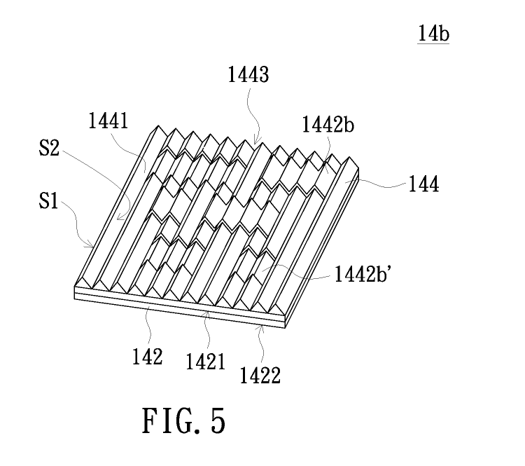

Referring to FIG. 5, FIG. 5 shows a three dimensional view of a hydrophilic film according to another embodiment of the invention. As shown in FIG. 5, in this embodiment, the second microstructures of the hydrophilic film 14b include several recessions 1442b′ forming on the first microstructures 1441 and several bumps 1442b forming on the first microstructures 1441. It should be understood that the bumps 1442b are similar to the bumps of the embodiment of FIG. 2 and the recessions 1442b′ are similar to the recessions of the embodiment of FIG. 4. That is to say that the hydrophilic film 14b includes the bumps of the embodiment of FIG. 2 and the recessions of the embodiment of FIG. 4.

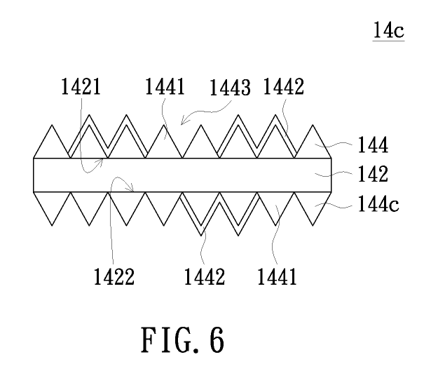

Referring to FIG. 6, FIG. 6 shows a three dimensional view of a hydrophilic film according to another embodiment of the invention. As shown in FIG. 6, in this embodiment, the hydrophilic film 14c includes two hydrophilic layers 144/144c respectively disposed on the first surface 1421 and the second surface 1422 of the substrate 142.

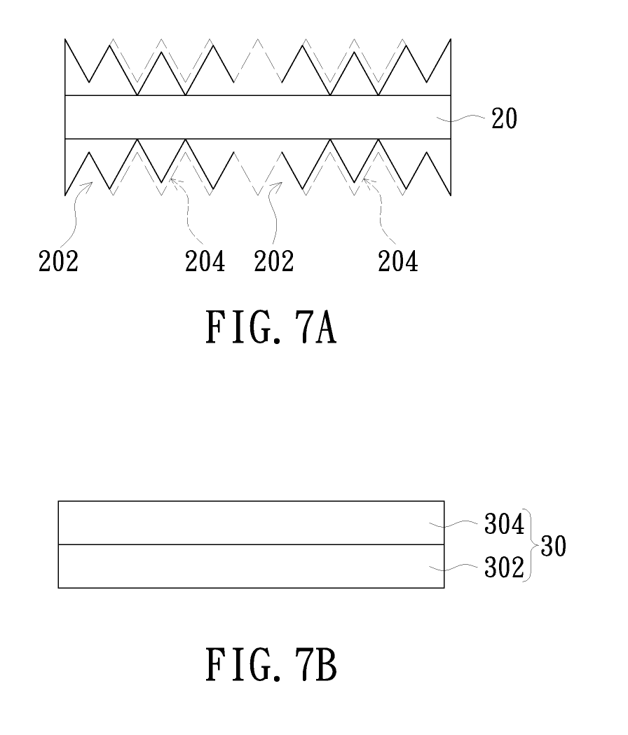

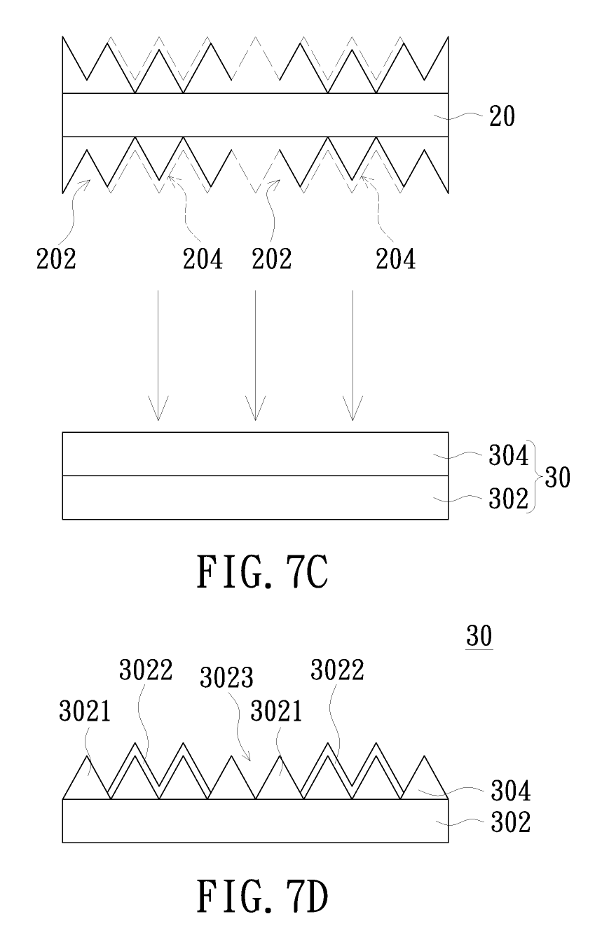

Referring to FIGS. 7A-7D, FIGS. 7A-7D show flow charts of a method of manufacturing a hydrophilic film according to an embodiment of the invention. Firstly, as shown in FIG. 7A, a mold 20 is provided. In this embodiment, the mold 20 is, but not limited to, a roller. The mold 20 includes several first graphs 202 and several second graphs 204 distributed on the first graph 202. Then, as shown in FIG. 7B, a pre-hydrophilic film 30 is provided and the pre-hydrophilic film 30 includes a substrate 302 and a hydrophilic layer 304 disposed on the substrate 302. The hydrophilic layer 304 is connected to the substrate 302 by the ways of roll pressing, spraying or immersing. Next, as shown in FIG. 7C, an imprint step is processed and used for imprinting the hydrophilic layer 304 of the pre-hydrophilic film 30 with the mold 20. As shown in FIG. 7D, after the pre-hydrophilic film 30 is roll pressed by the mold 20, several first microstructures 3021 are formed on the hydrophilic layer 304 and several second microstructures are 3022 distributed on the first microstructures 3021, in which two of the first microstructures 3021 form a groove 3023 between, a shape of each of the first microstructures 3021 is contrary to one of the first graphs 202 and a shape of each of the second microstructures 3022 is contrary to one of the second graphs 204.

In some embodiments, the first graphs 202 and the second graphs 204 of the mold 20 may be, but not limited to, formed by a chemical etching. In another embodiment, the first graphs 202 and the second graphs 204 of the mold 20 may be, but not limited to, formed by a physical etching.

In the embodiment, the first graphs 202 of the mold 20 may be, but not limited to, trenches and the second graphs 204 may be, but not limited to, caved in laterals of the trenches. After the pre-hydrophilic film 30 is pressed by the mold 20, the shape of each of the first microstructures 3021 is contrary to one of the trenches. In other words, the first microstructures protrude to form embossments shaped as prisms or semi-cylinders. The shape of each of the second microstructures 3022 is, but not limited to, contrary to one of the second graphs 204 to form a bump. In some embodiments, the second graphs 204 of the mold 20 may protrude from the laterals of the first graphs 202 to form the second microstructures 3022 having recession shapes on the first microstructures 3021.

In another embodiment, the method of manufacturing a hydrophilic film further includes a step as following. When the pre-hydrophilic film 30 is pressed by the mold 20, a curing step is processed and used for curing the hydrophilic layer 304 of the pre-hydrophilic film 30 to solidify the shapes of the first microstructures 3021 and the second microstructures 3022, forming a hydrophilic film. The curing step includes an ultraviolet curing or a thermal curing.

From the above, the hydrophilic film of the biosensor of the embodiment has several first microstructures and several second microstructures, in which the second microstructures are distributed on the first microstructures. Then, each of the grooves is formed between two of the first microstructures. The first microstructures, the second microstructures and the grooves may control the fluid speed of the liquid sample and guide the flow of the liquid sample to improve the sensing precision of the biosensor. Moreover, the flowing distance of the liquid sample is advanced to complete the object which is reducing the required quantity of the liquid sample. In addition, the invention provides the hydrophilic films, which do not attach to each other when stacked together, enhancing the manufacturing efficiency and preventing from risks of the adsorptive effects. Furthermore, the hydrophilic film has several first microstructures and several second microstructures to change the surface roughness of the hydrophilic film, so as to enhance the adhesion of the hydrophilic film for applying another coating layer to the hydrophilic film.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A hydrophilic film for a biosensor configured to sense a liquid sample, the hydrophilic film comprising:
a substrate; and
at least one hydrophilic layer disposed on the substrate and comprising a plurality of first microstructures, a plurality of second microstructures, and a plurality of grooves, wherein the first microstructures protrude in a direction opposite to the substrate, each of the grooves is formed between two of the first microstructures, the second microstructures are disposed on the first microstructures, the liquid sample contacts with the hydrophilic layer to form a contact angle, and the contact angle is less than 30 degree.

2. The hydrophilic film according to claim 1, wherein the substrate comprises a first surface and a second surface opposite to the first surface and the hydrophilic layer is disposed on the first surface of the substrate.

3. The hydrophilic film according to claim 1, wherein the substrate comprises a first surface and a second surface opposite to the first surface, and the hydrophilic layers are respectively disposed on the first surface and the second surface of the substrate when the number of the hydrophilic layers is two.

4. The hydrophilic film according to claim 1, wherein each of the second microstructures is a bump protruding in a direction away from the first microstructures.

5. The hydrophilic film according to claim 1, wherein each of the second microstructures is a recession descending in a direction toward the first microstructures.

6. The hydrophilic film according to claim 1, wherein the second microstructures comprise a plurality of recessions descending in a direction toward the first microstructures and a plurality of bumps protruding in a direction away from the first microstructures.

7. The hydrophilic film according to claim 1, wherein the second microstructures forms a grain disposed on the first microstructures and the grain is a discontinuous grain.

8. The hydrophilic film according to claim 1, wherein each of the first microstructures is a semi-cylinder with an arc protruding in the direction opposite to the substrate.

9. The hydrophilic film according to claim 1, wherein each of the first microstructures is a triangular prism comprising a first ramp and a second ramp.

10. A method of manufacturing a hydrophilic film comprising:
providing a mold comprising a plurality of first graphs and a plurality of second graphs distributed on the first graph;
providing a pre-hydrophilic film comprising a substrate and a hydrophilic layer disposed on the substrate; and
imprinting the pre-hydrophilic film with the mold to form a plurality of first microstructures located on the hydrophilic layer, a plurality of second microstructures distributed on the first microstructures, and a plurality of grooves, wherein each of the grooves is formed between two of the first microstructures, a shape of each of the first microstructures is contrary to one of the first graphs, and a shape of each of the second microstructures is contrary to one of the second graphs.

11. The method according to claim 10, wherein the mold is a roller.

12. The method according to claim 10, further comprising:
performing a curing process for curing the hydrophilic layer on the pre-hydrophilic film to form a hydrophilic film.

13. The method according to claim 12, wherein the curing process comprises an ultraviolet curing or a thermal curing.

14. A biosensor for sensing a liquid sample, the biosensor comprising:
an insulated substrate comprising a reacting area and at least two electrodes passing into the reacting area; and
a hydrophilic film disposed on the insulated substrate and covering the electrodes, the hydrophilic film comprising:
a substrate; and
at least one hydrophilic layer disposed on the substrate and comprising a plurality of first microstructures, a plurality of second microstructures, and a plurality of grooves, wherein the first microstructures protrude in a direction opposite to the substrate, each of the grooves is formed between two of the first microstructures, the second microstructures are disposed on the first microstructures, the liquid sample contacts with the hydrophilic layer to form a contact angle, and the contact angle is less than 30 degree when the liquid sample is contacted on the hydrophilic layer.

15. The biosensor according to claim 14, further comprising a cover covering the hydrophilic film opposite to the insulated substrate.

16. The biosensor according to claim 14, wherein each of the second microstructures is a bump protruding in a direction away from the first microstructures.

17. The biosensor according to claim 14, wherein each of the second microstructures is a recession descending in a direction toward the first microstructures.

18. The biosensor according to claim 14, wherein the second microstructures comprise a plurality of recessions descending in a direction toward the first microstructures and a plurality of bumps protruding in a direction away from the first microstructures.
